(19) United States
(12) Patent Application Publication
(10) Pub. No.: US 2026/0332616 A1
(43) Pub. Date: Oct. 22, 2026

(54) OPERATIONAL ANOMALY DETECTION AND ISOLATION IN MULTI-DOMAIN COMMUNICATION NETWORKS

(71) Applicant: Telefonaktiebolaget LM Ericsson (publ), Stockholm (SE)

(72) Inventors: Attila MITCSENKOV, Budapest (HU); Alexander BIRO, Budapest (HU); Botond VARGA, Budapest (HU); Vilma ORGOVÁNYI, Budapest (HU)

(73) Assignee: Telefonaktiebolaget LM Ericsson (publ), Stockholm (SE)

(21) Appl. No.: 19/104,707

(22) PCT Filed: Sep. 14, 2022
(86) PCT No.: PCT/IB2022/058674

§ 371 Date: Feb. 19, 2025

(51) Int. Cl. H04L 9/40

(52) U.S. Cl. CPC H04L 63/1425

(57) ABSTRACT

Embodiments include computer-implemented methods for detecting operational anomalies in a multi-domain communication network. Such methods include obtaining a plurality of time series of performance data from multiple domains of the communication network and determining one or more models of non-anomalous network behavior based on the plurality of time series. Such methods include classifying the respective time series into a plurality of types based on the presence or absence of at least two types of components in the respective time series. Such methods include detecting for operational anomalies, based on the one or more models and the classified types, in the plurality of time series or in further performance data obtained from the multiple domains of the communication network. Other embodiments include network analytics systems configured to perform such methods.

### TECHNICAL FIELD

The present disclosure relates generally to communication networks and more specifically to techniques for detecting operational anomalies (e.g., failures, etc.) that manifest themselves across multiple domains of a communication network.

### BACKGROUND

The fifth generation (“5G”) of cellular systems, also referred to as New Radio (NR), was initially standardized 3GPP Rel-15 and continues to evolve in subsequent releases. NR is developed for maximum flexibility to support a variety of different use cases including enhanced mobile broadband (eMBB), machine type communications (MTC), ultra-reliable low latency communications (URLLC), side-link device-to-device (D2D), and several other use cases. 5G/NR technology shares many similarities with fourth-generation LTE.

At a high level, the 5G System (5GS) consists of an Access Network (AN) and a Core Network (CN). The AN provides UEs connectivity to the CN, e.g., via base stations such as gNBs or ng-eNBs. As described in more detail below, the CN includes a variety of Network Functions (NF) that provide a range of different functionalities such as session management, connection management, charging, authentication, etc.

The ever increasing complexity of communication networks, including 5G networks, drives the evolution of analytics systems that support operation, optimization, and planning of these networks. This includes detecting and addressing sudden, undesired changes in network operation and/or performance (e.g., failures). These analytics systems, in turn, require collecting and processing of enormous amounts of data, particular time series data.

In general, a time series is a sequence of data or information values, each of which has an associated time instance (e.g., when the data or information value was generated and/or collected). The data or information can be anything measurable that depends on time in some way, such as prices, humidity, or number of people. One important characteristic of a time series is frequency, which is how often the data values of the data set are recorded. Frequency is also inversely related to the period (or duration) between successive data values.

Time series analysis includes techniques that attempt to understand or contextualize time series data, such as to make forecasts or predictions of future data (or events) using a model built from past time series data. To best facilitate such analysis, it is preferrable that the time series consists of data values measured and/or recorded with a constant frequency or period.

Time series datasets can be collected from geographic locations, such as from nodes of a communication network located in one or more geographic areas (e.g., countries, regions, provinces, cities, etc.). For example, values of performance measurement (PM) counters can be collected from the various network nodes at certain time intervals. Time series data collected in this manner can be used to analyze, predict, and/or understand user behavior patterns as well as network performance trends.

### SUMMARY

However, detecting and addressing sudden, undesired changes in network operation and/or performance (e.g., failures or anomalies) can be very difficult, even with large amounts of available time series data.

For example, advanced communication networks are robust and distributed so that failures have relatively limited impact to a subset of users, sessions, and/or network elements, making them more difficult to detect. Furthermore, normal network behavior varies by time-of-day, day-of-week, month, and/or season. The presence or absence of these trends needs to be considered when detecting anomalous network behavior. Additionally, each available time series of data is typically one-dimensional, such that it is collected from a single network node and is uncorrelated with other data sources. As such, it is more difficult to detect failures that manifest themselves in multiple network nodes.

Embodiments of the present disclosure address these and other problems, issues, and/or difficulties by providing techniques that detect and isolate communication network operational anomalies based on correlated data sources from a various network domains, and corresponding network analytics system that perform such techniques.

Some embodiments include methods (e.g., procedures) for detecting operational anomalies in a multi-domain communication network.

These exemplary methods can include obtaining a plurality of time series of performance data from multiple domains of the communication network. These exemplary methods can also include determining one or more models of non-anomalous network behavior based on the plurality of time series. These exemplary methods can also include classifying the respective time series into a plurality of types based on the presence or absence of at least two types of components in the respective time series. These exemplary methods can also include detecting for operational anomalies, based on the one or more models and the classified types, in the plurality of time series or in further performance data obtained from the multiple domains of the communication network.

In some embodiments, these exemplary methods can also include, based on detecting a plurality of operational anomalies in the further performance data, determining an order of importance of the detected operational anomalies based on respective deviations from corresponding non-anomalous network behavior. In some of these embodiments, these exemplary methods can also include, in response to one or more detected anomalies determined to be most important, initiating one or more corrective actions in a plurality of the domains of the communication network. In some of these embodiments, these exemplary methods can also include, in response to one or more detected anomalies determined to be less important, refraining from initiating one or more further corrective actions in one or more domains of the communication network.

In some embodiments, classifying the respective time series based on the presence or absence of at least two types of components includes the following operations:
detecting whether each of the time series includes a seasonal component and/or a non-constant trend component;
classifying a time series as a first type when the time series includes a seasonal component;
classifying a time series as a second type when the time series includes a non-constant trend component but does not include a seasonal component; and
classifying a time series as a third type when the time series includes neither a non-constant trend component nor a seasonal component.

Various examples of obtained performance data, determined models of non-anomalous behavior, and detecting for operational anomalies are disclosed herein.

Other embodiments include network analytics systems (e.g., NWDAFs, SMO nodes, NM nodes, cloud systems, etc.) configured to perform operations corresponding to any of the exemplary methods described herein. Other embodiments include non-transitory, computer-readable media storing program instructions that, when executed by processing circuitry, configure such network analytics systems to perform operations corresponding to any of the exemplary methods described herein.

These and other embodiments described herein can provide a wide range of possibilities to investigate various known network failures as well as fast, automatic detection of yet unknown network failures. In this manner, embodiments can capture novel anomalies early while they are still developing, minimizing their impact on user experience and network performance. Furthermore, anomaly detection based on learning normal network behavior has significant advantages over conventional, threshold-based alarm systems, since many KPIs depend on factors such as time-of-day, day-of-week, network load, etc. Additionally, by monitoring and correlating network-wide key performance indicators (KPIs), embodiments can isolate UEs, data sessions, etc. that are impacted by an unidentified failure or interworking issue. In addition to more visible network failures that are often identified by conventional techniques, embodiments can identify more latent failures and interworking issues that are often missed by conventional techniques.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 is a high-level block diagram of an exemplary 5G/NR network architecture.

FIG. 2 shows an exemplary 5G reference architecture with service-based interfaces and various 3GPP-defined NFs.

FIG. 3 shows an exemplary multi-domain network comprising a RAN, a packet-based core network (CN), and an IP Multimedia Subsystem (IMS).

FIGS. 4-7 show various exemplary time series of network performance data collected over a period of approximately four (4) weeks.

FIG. 8 shows a functional diagram of a network analytics system according to embodiments of the present disclosure.

FIGS. 9-12 shows an exemplary time series of network performance data and three components extracted from this time series using embodiments of the present disclosure.

FIG. 13 shows an exemplary time series including a trend component detected according to embodiments of the present disclosure.

FIG. 14 shows the remaining component of the time series in FIG. 13 after removal of the trend component.

FIGS. 15-17 shows an exemplary arrangement of upper and lower bounds for anomaly detection for multiple composite time series and two individual time series, according to embodiments of the present disclosure.

FIG. 18 shows an exemplary implementation of a network analytics system according to embodiments of the present disclosure.

FIG. 19 shows a high-level diagram of an Open RAN (O-RAN) architecture.

FIGS. 20-21 show two implementation options for integrating embodiments of the present disclosure with an O-RAN architecture.

FIG. 22 shows an exemplary method (e.g., procedure) for detecting operational anomalies in a multi-domain communication network, according to various embodiments of the present disclosure.

FIG. 23 shows a communication system according to various embodiments of the present disclosure.

FIG. 24 shows a network node according to various embodiments of the present disclosure.

FIG. 25 shows host computing system according to various embodiments of the present disclosure.

FIG. 26 is a block diagram of a virtualization environment in which functions implemented by some embodiments of the present disclosure may be virtualized.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

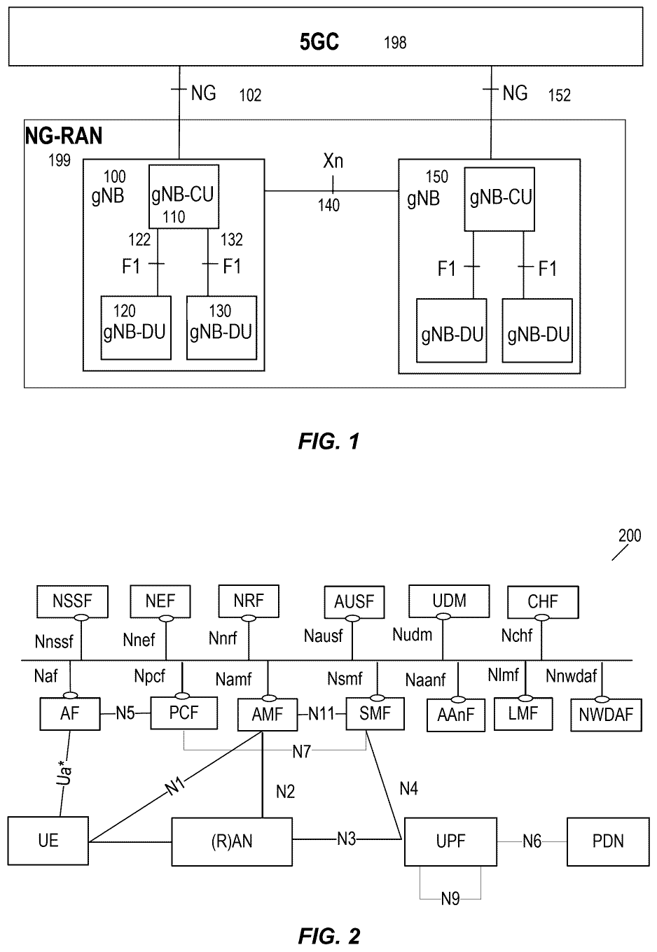

FIG. 1 shows a high-level view of an exemplary 5G network 100, including a Next Generation RAN (NG-RAN) 199 and a 5G Core (5GC) 198. NG-RAN 199 can include a set of gNodeB's (gNBs) connected to the 5GC via one or more NG interfaces, such as gNBs 100, 150 connected via interfaces 102, 152, respectively. In addition, the gNBs can be connected to each other via one or more Xn interfaces, such as Xn interface 140 between gNBs 100 and 150. With respect the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a Central Unit (CU or gNB-CU) and one or more Distributed Units (DU or gNB-DU). For example, gNB 100 includes gNB-CU 120 and gNB-DUs 120 and 130. CUs (e.g., gNB-CU 120) are logical nodes that host higher-layer protocols and perform various gNB functions such controlling the operation of DUs. A DU (e.g., gNB-DUs 120, 230) is a decentralized logical node that hosts lower layer protocols and can include, depending on the functional split option, various subsets of the gNB functions. A gNB-CU connects to one or more gNB-DUs over respective F1 logical interfaces (e.g., 122 and 132).

One change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

Furthermore, the services are composed of various “service operations”, which are more granular divisions of the overall service functionality. The interactions between service consumers and producers can be of the type “request/response” or “subscribe/notify”. In the 5G SBA, network repository functions (NRF) allow every network function to discover the services offered by other network functions, and Data Storage Functions (DSF) allow every network function to store its context. This 5G SBA model is based on principles including modularity, reusability and self-containment of NFs, which can enable network deployments to take advantage of the latest virtualization and software technologies.

FIG. 2 shows an exemplary non-roaming architecture of a 5G network (200) with service-based interfaces and various 3GPP-defined NFs. These include the following NFs, with additional details provided for those most relevant to the present disclosure:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF) supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point, with SMFs via the N11 reference point, and with RAN (e.g., NG-RAN) via the N2 reference point.
Network Exposure Function (NEF) with Nnef interface—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs. In general, NEF provides services similar to services provided by SCEF in EPC.
Network Repository Function (NRF) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Network Data Analytics Function (NWDAF) with Nnwdaf interface—interacts with other NFs to collect relevant data and provides network analytics information (e.g., statistical information of past events and/or predictive information) to other NFs.
Location Management Function (LMF) with NImf interface—supports various functions related to determination of UE locations, including location determination for a UE and obtaining any of the following: DL location measurements or a location estimate from the UE; UL location measurements from the NG RAN; and non-UE associated assistance data from the NG RAN.

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF. The terms “UDM” and “UDM function” are used interchangeably herein.

IP Multimedia Subsystem (IMS) is an architectural framework for delivering multimedia services to wireless devices based on these Internet-centric protocols. IMS was originally specified by 3rd Generation Partnership Project (3GPP) in Release 5 (Rel-5) as a technology for evolving mobile networks beyond GSM, e.g., for delivering Internet services over GPRS. IMS has evolved in subsequent releases to support other access networks and a wide range of services and applications.

At a high-level, the functionality of the IMS network can be sub-divided into two types: control and media, and application enablers. The control functionality comprises Call Session Control Function (CSCF) and Home Subscriber Server (HSS). The CSCF is used for session control for devices and applications that are using the IMS network. Session control includes the secure routing of the session initiation protocol (SIP) messages, subsequent monitoring of SIP sessions, and communicating with a policy architecture to support media authorization. CSCF functionality can also be divided into Proxy CSCF (P-CSCF), Serving CSCF (S-CSCF), and Interrogating CSCF (I-CSCF).

CSCF also interacts with the HSS, which is the master database containing user and subscriber information to support the network entities handling calls and sessions. For example, HSS provides functions such as identification handling, access authorization, authentication, mobility management (e.g., which session control entity is serving the user), session establishment support, service provisioning support, and service authorization support.

A Media Resource Function (MRF) can provide media services in a user's home network and can manage and process media streams such as voice, video, speech-to-text, and real-time transcoding of multimedia data. In general, a WebRTC Gateway allows native-and browser-based devices to access services in the network securely.

As briefly mentioned above, the ever increasing complexity of communication networks, including 5G networks, drives the evolution of analytics systems that support operation, optimization, and planning of these networks. This includes detecting and addressing sudden, undesired changes in network operation and/or performance (e.g., failures). Advanced analytics systems require collecting and correlating elementary network events from different network domains, such as CN, RAN, and transport networks. Such analytics systems calculate user-and session-level E2E service quality metrics (S-KPIs) as well as radio and network resource metrics (R-KPIs) that characterize the radio environment or network operation at user and session level.

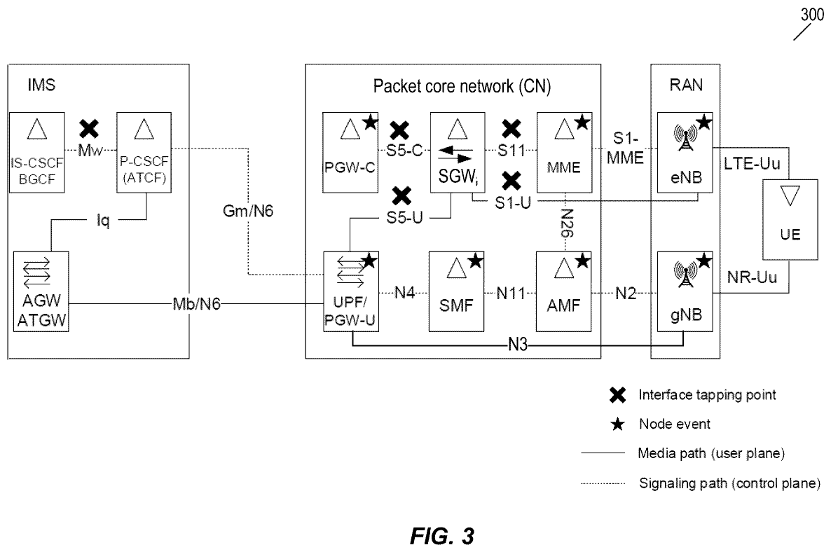

FIG. 3 shows an exemplary multi-domain network (300) comprising a UE, a RAN, a packet-based CN, and an IMS. As shown in FIG. 3, the RAN includes eNBs that provide the LTE-Uu radio interface and gNBs that provide the NR-Uu interface to UEs. The CN includes SMF, AMF, and UPF in 5GC discussed above, as well as mobility management entity (MME), serving gateway (SGW), and packet gateway (PGW) that are part of the Evolved Packet Core (EPC) associated with LTE networks. The UPF connects to the IMS via the N6 interface, such that IMS in FIG. 3 is an instance of the PDN shown in FIG. 2.

FIG. 3 also shows various “tapping points” where data can be collected from the three domains of the network. For example, node events (e.g., PM counters) can be collected from eNBs, gNBs, AMF, SMF, UPF, MME, and PGW. Likewise, interface events can be collected from S5-U (user), S5-C (control), S1-U, and S5-U interfaces in CN as well as from Mw interface between P-CSCF and IS-CSCSF in IMS. In addition to detecting events and/or conditions at the individual nodes and/or interfaces, some more advanced analytics systems combine information collected from the multiple domains to determine “user experience” analytics that represent performance experienced by an end user for a specific service.

Time series datasets can be collected from various nodes and various interface in multiple domains of a communication network. Time series data collected in this manner can be used to analyze, predict, and/or understand user behavior patterns as well as network performance trends. However, detecting and addressing sudden, undesired changes in network operation and/or performance (e.g., failures or anomalies) can be very difficult, even with large amounts of available time series data. For example, advanced communication networks (such as the exemplary network shown in FIG. 3) are robust and distributed so that failures have relatively limited impact to a subset of users, sessions, and/or network elements, making them more difficult to detect.

One conventional approach to fault detection and troubleshooting involves manual search for erroneous elements, using a wide variety of filtering options provided by network monitoring and analytics tools. In general, these advanced tools provide the ability to investigate a variety of network issues. However, finding an unknown problem is nearly impossible if only a random search among available data is used.

Another approach is fixed alarm thresholds set for various network KPIs or metrics. This can be used for problematic conditions and/or to avoid manual searching. However, there is a tradeoff between sensitivity and false alarms. If the thresholds are set too low, the system becomes overloaded with a high number of alarms; if set too high, only the highly serious issues will be detected and often later than desired.

Another general approach is anomaly detection, which sets alarms based on based on observed distributions of network KPIs or metrics. In this manner, events that are outliers (in some statistical sense) relative to typical or normal values will be detected.

Even so, these techniques are not always successful. Network behavior considered as “normal” (based on KPIs or metrics) varies by time-of-day, day-of-week, month, and/or season, as well as by network load and many other variables. The presence or absence of these trends needs to be considered when detecting anomalous network behavior. Furthermore, different KPIs and metrics may have different variability or dependence on these factors.

Additionally, each time series of data collected from a multi-domain network (e.g., as shown in FIG. 3) is typically one-dimensional, such that it is collected from a single network element (e.g., node, interface, etc.) and is uncorrelated with other data sources. While this supports detecting failures with measurable impact on a single network element, it is difficult to detect failures that manifest themselves in multiple network elements.

Other existing techniques have similar shortcomings. U.S. Pat. No. 8,200,193 describes a UE-based technique for identifying abnormal traffic generated by a unique UE but does not detect network-level issues. U.S. Pat. Pubs. 2021/0058424 and 2020/0106795 disclose techniques for anomaly detection in communication networks that focus on performance metrics of single elements (e.g., microservices or nodes), without considering multi-dimensional network structure or behavioral distinctions between in time series data (e.g., periodicity, trend, etc.). U.S. Pat. No. 7,460,498 describes techniques for detecting issues with fixed telecommunication lines based on measurements of individual network elements, also without considering multi-dimensional network structure.

Embodiments of the present disclosure address these and other problems, issues, and/or difficulties by novel, flexible, and efficient techniques that detect and isolate communication network operational anomalies based on correlated time-series data sources from various network domains, and corresponding network analytics system that perform such techniques. Some aspects include:
Robust learning of time series behavior, exploiting relationship of various time series describing a variety of marginal distributions of KPIs from a complex network to correct errors and anomalies in the training data;
Classification of time series with respect to their seasonality, existence, and/or changepoints of trends;
Targeted anomaly detection applied to various classes of time series; and
Isolation of network issues and/or anomalies within the multi-dimensional space represented by the time series, by finding the filtering that highlights the maximal impact on monitored KPIs.

Correlation of data from various sources for each user session enables filtering by a variety of dimensions and combinations thereof. For example, embodiments can support calculating call drop rates for UEs from vendor A on cells from RAN vendor B, or video quality for users of service provider C in region D.

Each collected time series of data can be considered a marginal distribution of network performance or user experience within a particular dimension, with the full network performance being represented by the multi-dimensional set of time series that have unknown relationships between them (i.e., between the marginal distributions).

Embodiments apply anomaly detection to this multi-dimensional set of time series to automatically detect issues during network operations. The monitored network performance metrics and user experience KPI time series are first classified by the existence of seasonal and trend components, and the anomaly detection first learns the normal network behavior.

The relationships between the time series of the multi-dimensional system are used to ensure robustness when learning normal behavior of the network in an unsupervised system. In some embodiments, an underfitted Machine Learning (ML) model trained based on L1 regularization can be used to suppress the impact of anomalies in training data. This approach provides an intelligent noise filtering capability and allows the ML model to learn the periods of normal behaviors without capturing minor abnormalities that are present only in a subset of the otherwise related time series.

Network issues or abnormal behavior correspond to detected anomalies. Embodiment can apply filtering and ranking to these network anomalies to differentiate between, for example, abnormal network operation and abnormal network load. Dependence of the observed metrics and KPIs on the underlying traffic can also be taken into consideration.

In some embodiments, the marginal distributions of KPIs for multiple dimensions (and dimension combinations) are used to isolate problematic network elements on the end-to-end data path by identifying their contribution to observed performance degradation. Network failures typically impact multiple identifiable groups of subscribers (i.e., marginal distributions of a certain KPI) as “side effects” beyond the actual trigger or root cause of the problem. For example, a serious YouTube service outage (root cause) might impact the video QoE metrics of all Apple terminals (side effect).

Embodiments can provide various benefits and/or advantages. For example, embodiments provide almost infinite possibilities to investigate various known network failures but also provide fast, automatic anomaly detection for yet unknown network failures. In this manner, embodiments can capture novel anomalies early while they are still developing, minimizing their impact on user experience and network performance.

Furthermore, anomaly detection based on learning normal network behavior has significant advantages over conventional, threshold-based alarm systems, since many KPIs depend on factors such as time-of-day, day-of-week, network load, etc. Having thresholds adaptive to these factors significantly increases the reliability of fault detection. Moreover, embodiments utilize a learning system that reduces and/or eliminates impact of training time errors on fault detection during operation.

Additionally, by monitoring and correlating network wide QoS/QoE KPIs, embodiments can accurately isolate UEs, data sessions, etc. that are impacted by an unidentified failure or interworking issue. Beyond more visible network element failures that are often identified by conventional FM/PM techniques, embodiments can also identify more latent failures and interworking issues that are often missed by these conventional techniques.

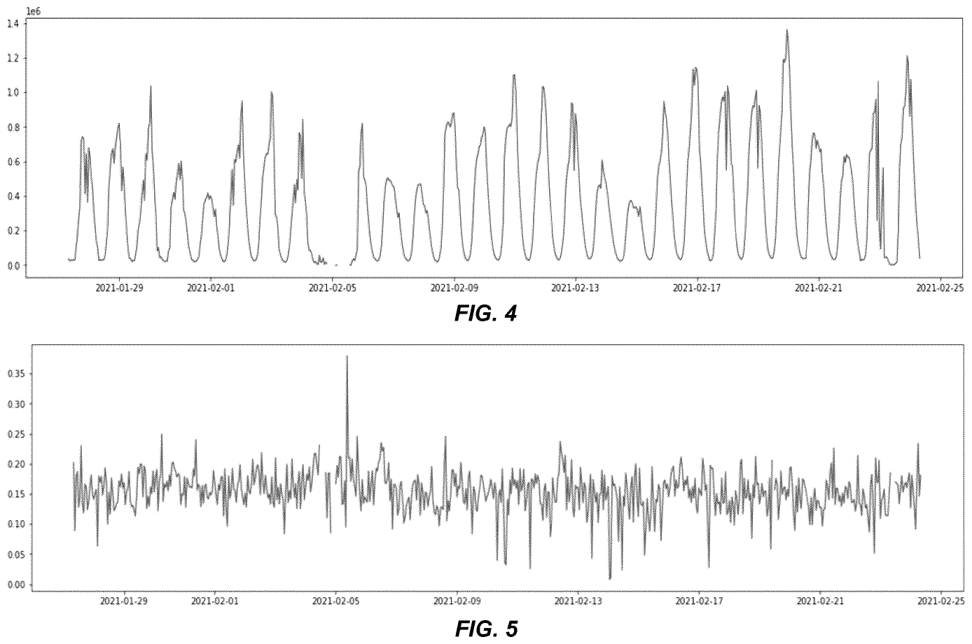

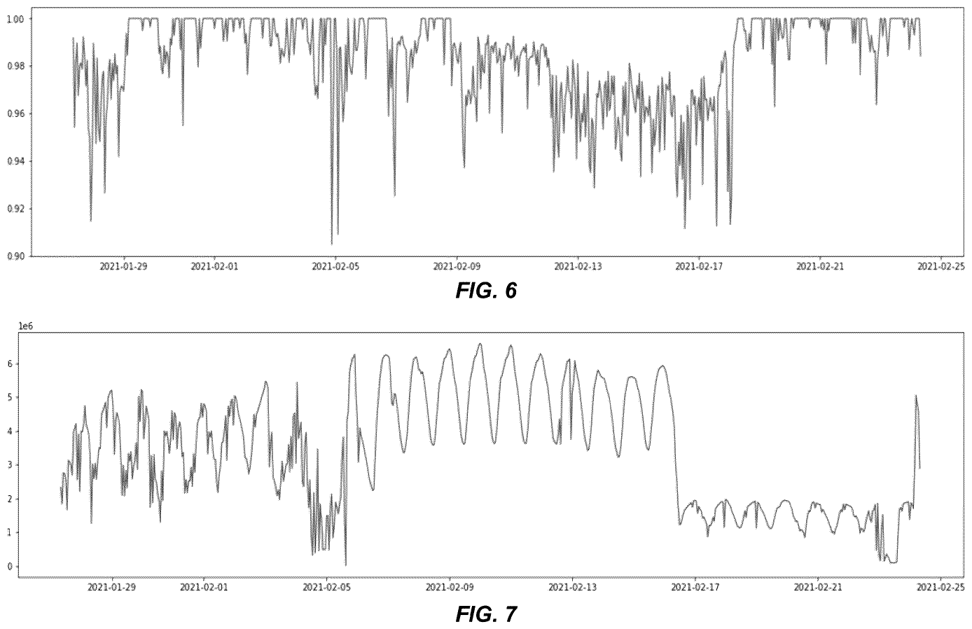

Time-series data collected in a communication network (e.g., as shown in FIG. 3) can have various formats, characteristics, and/or patterns. FIGS. 4-7 show various exemplary time series collected over a period of approximately four (4) weeks. The time series in FIG. 4 has a daily pattern with a peak hour and minimum turnover point, while the time series in FIG. 5 has a more random pattern but includes a single event represented by the peak value. The time series in FIG. 6 also has a random pattern but also includes a non-constant trend component. Finally, the time series in FIG. 7 has a daily pattern similar to FIG. 4 but also includes a non-constant trend component similar to FIG. 6.

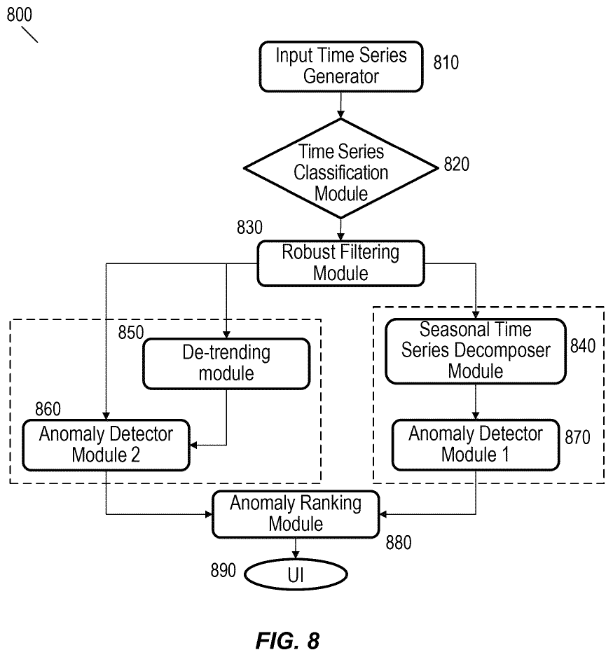

Embodiments of the present disclosure can detect anomalies in time series data with these and other formats, characteristics, and/or patterns. FIG. 8 shows a functional diagram of a network analytics system according to embodiments of the present disclosure. This exemplary system includes various modules or functions that filter for anomalies (representing network issues) and sorts them based on their importance.

The Input Time Series Generator function (810) delivers formatted time-series data. This module can correlate and/or aggregate data for any given granularity (e.g., minute, hour, day, etc.) and for any dimension (e.g., UE vendor, network region, user subscription type, carrier frequency, etc.), as well as combinations thereof (vendor-model-operating system-IMEI software version number, functionality-service provider, tracking area-service provider, etc.). Each correlated and/or aggregated time series produced by this function can be considered a “marginal distribution” of the behavior of the multi-dimensional system in one or more dimensions. The output of this function is the data source for the rest of the system.

The Time Series Behavior Module (820) classifies each time series output by the Input Time Series Generator function according to behavior. The system later performs different processing on each time series based on this classification.

For example, the time series can be classified into four categories based on the presence of a non-constant trend component and/or a seasonal component. The distinction between seasonal and non-seasonal data is necessary because treating a seasonal data as non-seasonal can result in failure to detect anomalies in non-busy hours. In case of seasonal data, the presence or absence of a trend component does not affect subsequent analysis, since detectors can handle trend and seasonality together. In case of non-seasonal data, however, the presence or absence of a trend component leads to different processing, as described below.

The classification performed in this module can be implemented in various ways. Some statistical tests for seasonality include the Welch test (a two-sample location test used to test a hypothesis that two populations have equal means) and the QS-test (a variant of Ljung-Box text computed on seasonal lags considering only positive autocorrelations). Some statistical tests for changing trend components include stationarity tests and Kolmogorov-Smirnov tests. It is also possible to use ML techniques such as autoencoders, which are artificial neural networks (NN) that can learn patterns in data in an unsupervised manner.

The Robust Filtering Module (830) applies unsupervised learning techniques to suppress abnormal behavior in the respective time series during training. This facilitates an accurate prediction of “normal” behavior even if the training data includes anomalies.

A major vulnerability of (unsupervised) anomaly detection techniques is their sensitivity to anomalies in training data. In such cases, conventional analytics system are unable to learn “normal” network behavior, and training time anomalies will divert predictions.

Embodiments of the present disclosure provide robustness against training time errors by exploit the fact that the system is not fed by a set of independent time series, but rather by time series that are different marginal distributions (e.g., of KPIs) for one complex, multi-dimensional system. Since the actual relationships between these marginal distributions are not known in advance, embodiments apply an ML model to learn “normal behavior” for all time series data in the context of a large, multi-dimensional system.

In some embodiments, this can be done by using an intentionally underfitted ML model (or system) based on L1 regularization applied to the weights of a NN comprising the ML model. L1 regularization minimizes a combined loss function of the NN weights and the norm of the NN weights, and promotes sparsity in which certain weights have optimal values of zero. This can be considered intelligent “noise filtering”, where predictions are made by “typical” values of time series according to their primary features, which represent the “normal” (i.e., non-anomalous) behavior of the network. Such features include dimensions, dimension combinations, and time domain features such as times-of-days, days-of-week, etc.

If a time series was previously classified as seasonal (with or without trend), it is input to the Seasonal Time Series Decomposer Module (840), which identifies any included seasonal behavior and trend, removes these effects from the time series, and makes predictions. By removing the seasonal behavior and trend, any prediction error is independent and identically distributed (i.i.d.).

The behavior of the trend component can vary with time, and complex seasonal patterns might be present in the data. Hence it is necessary to identify trend changepoints and multiple seasonal patterns such as daily/weekly seasonality. Some embodiments can apply Bayesian inference methods to extract this information from such complicated structures.

One exemplary Bayesian inference method is the Facebook Prophet algorithm, which uses a Markov Chain Monte Carlo (MCMC) sampling algorithm to fit and forecast time series data. In this approach, the timeseries are represented as y(t)=s(t)+g(t)+h(t)+ε(t), where t denotes time, s(t) denotes the daily/weekly seasonal component (which is assumed to be Fourier series), g(t) denotes the trend component (which is assumed to be piecewise linear), h(t) denotes the holiday component, and &(t) denotes the error component. The model parameters are assumed to follow predefined distributions. In a variant, the trend component can be multiplicative rather than additive, with the timeseries can be expressed as y(t)=g(t)*(1+s(t)+h(t))+ε(t).

Prophet uses a Bayesian model to find the best parameters (e.g., intercept, current initial slope, deltas between slopes) for the data. This process starts with a “prior” representing assumed values of the parameters before seeing the data. Given this prior and the data, the Bayesian model returns the “a posteriori”, i.e., the updated belief for the parameter values (i.e., with maximum probability). More specifically, Prophet uses a prior with a Laplace statistical distribution. It is known that the maximum a posteriori probability (MAP) estimate of a Bayesian model with a Laplace prior is equivalent to a linear regression with L1 regularization.

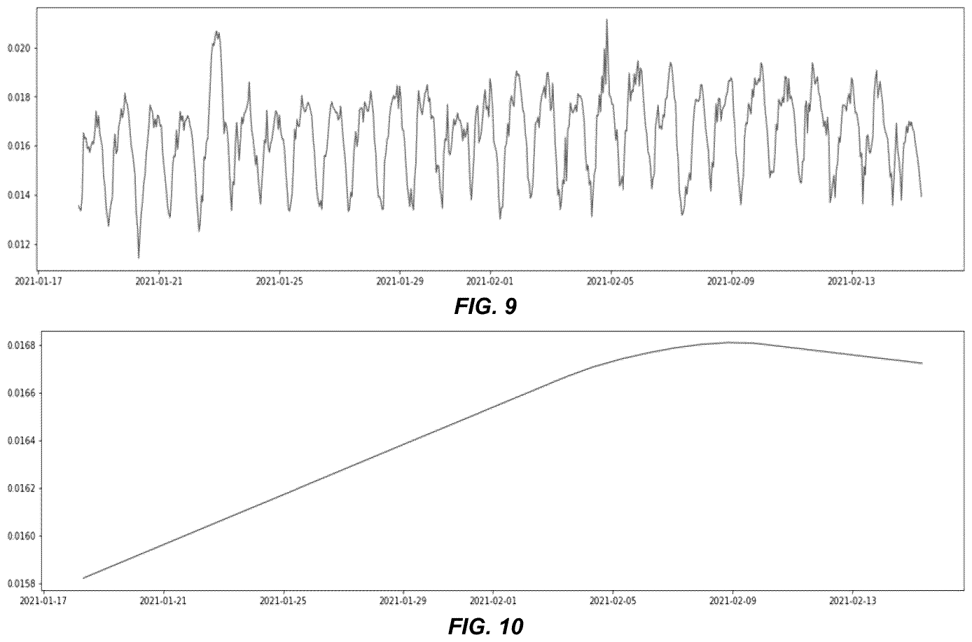

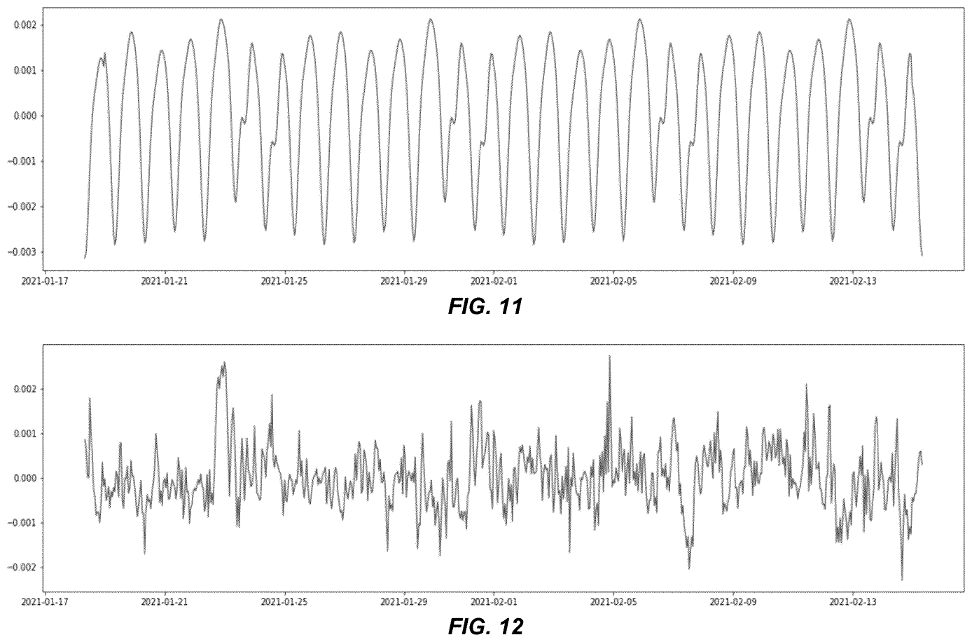

FIG. 9 shows an exemplary time series collected over a period of approximately four (4) weeks. FIGS. 10-12 respectively show a trend component g(t), a seasonality component s(t), and an error component ε(t) extracted from the time series shown in FIG. 9, according to embodiments of the present disclosure.

If a time series was previously classified as non-seasonal with trend, it is input to the De-trending Module (850) which identifies and removes the included trend to obtain the error term of the time series.

These time series do not possess any kind of seasonal behavior, or at least behavior too complex to be learned by computationally efficient statistical or ML techniques. Thus, these time series cannot be treated with seasonal models such as those mentioned above; otherwise noise will be treated as the missing seasonal component s(t) which will produce an incorrect decomposition of error component £(t). On the other hand, treating these time series as pure noise and learning population-wide behavior would prevent anomaly detection in any specific period. For example, rescaling in presence of a trend would compress the entire time series, by-passing time windows around the median or mean of the given time period.

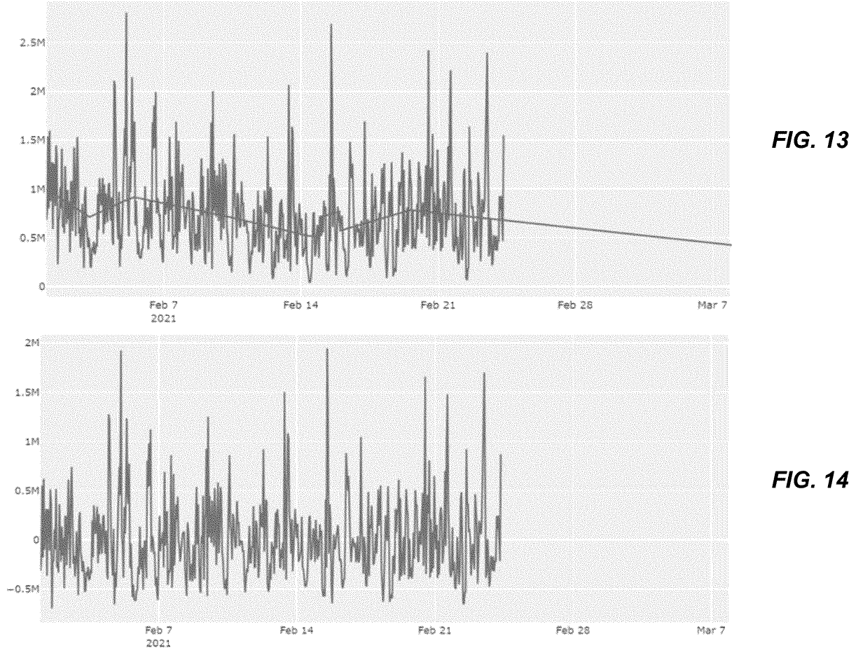

Embodiments of the present disclosure overcome these difficulties by decomposing non-seasonal timeseries with trend are decomposed into trend and error components. Embodiments model the trend component as piecewise linear to accommodate trend changes over time. FIG. 13 shows an exemplary time series in which the trend (detected according to embodiments of the present disclosure) is superimposed as a piecewise linear function.

Some embodiments can apply Bayesian inference methods to extract trend information from time series. For example, the timeseries can represented as y(t)=g(t)+h(t)+ε(t) or as y(t)=g(t)*(1+h(t))ε(t), where t denotes time, g(t) denotes the trend component (which is assumed to be piecewise linear), h(t) denotes the holiday component, and ε(t) denotes the error component.

In these embodiments, the De-trending Module estimates the trend and holiday part of the time series and eliminates them using Bayesian inference, such as:

ŷ(t)=y(t)−g(t)*(1+h(t)), or

ŷ(t)=y(t)−g(t)−h(t).

These remaining components are an estimate of the error function ε(t) are generally noise with some statistical distribution (e.g., white). FIG. 14 shows the remaining component of the time series in FIG. 13 after removal of the trend component also shown in FIG. 13.

These time series can be processed by the Anomaly Detector Module 2 (860). If a time series was previously classified as non-seasonal without trend, it is input directly to this module.

Anomaly Detector Module 1 (870) and Anomaly Detector Module 2 (860) may run in parallel based on their respective time series inputs from other modules described above. These modules learn the normal behavior and detect anomalies in the respective time series, based on comparing deviations of any time series to actual predictability of other similar time series. The outcome of both anomaly detector modules is a triggering or marking of any anomalous time periods on the respective time series.

Anomaly Detector Module 1 (870) utilizes various metrics of each input time series, such as rescaled error or trend component. To make anomaly detection more robust, this module operates on all input time series concurrently rather than analyzing them individually. The particular anomaly detector algorithm used depends on the chosen metric.

For example, any detector that assumes a white noise process can be used when the error component is the chosen metric. As a more specific example, approaches based on ML or extreme value theory can be used. More specifically, the second of these approaches is based on the Fisher-Tippett-Gnedenko Theorem, which states that the maximum of i.i.d. random variables has the same kind of (“extreme value”) distribution regardless of the distributions of the original random variables. Moreover, parameters of the maximum's distribution can be estimated using the original data. Since a maximum corresponds to an extreme event, this approach facilitates estimation of extreme event distributions. Note that the Fisher-Tippett-Gnedenko Theorem is analogous to the Central Limit Theorem for sums of i.i.d. random variables.

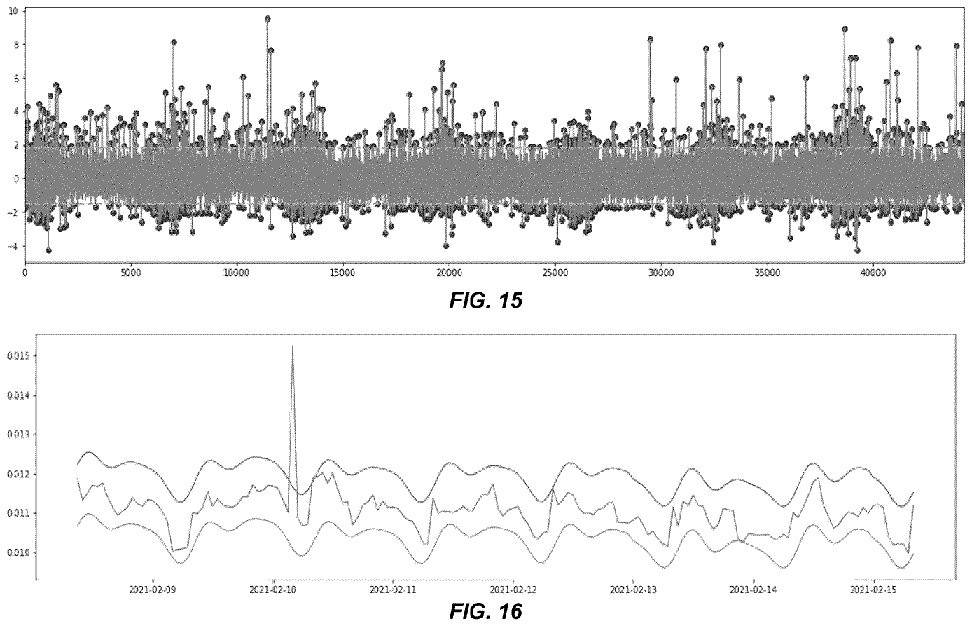

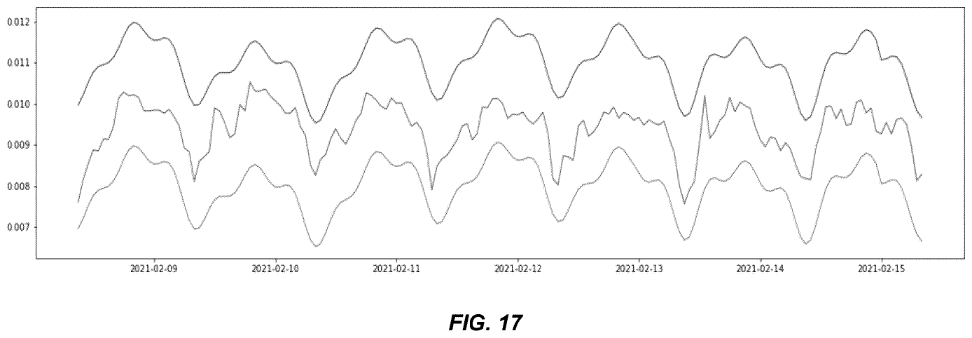

FIG. 15 shows an exemplary arrangement in which the Anomaly Detector Module 1 has created upper and lower bounds for multiple time series of data being analyzed concurrently, while FIGS. 16-17 show upper and lower bounds created for two individual time series, along with actual values for those respective time series. FIG. 16 shows one data point in that time series that may be detected as an anomaly.

Anomaly Detector Module 2 (860) handles time series data that has the characteristics of white noise with no trend or seasonality, with the distribution similar to a normal distribution. This module groups time series by KPIs and filters each KPI in various dimensions (i.e., marginal distributions). Clustering algorithms are used to identify outliers.

For example, this module can be implemented using density-based spatial clustering of applications with noise (DBSCAN), a density-based, non-parametric clustering algorithm. Given a set of points in some space, DBSCAN groups together points that points with many nearby neighbors, while marking as outliers the points in low-density regions with nearest neighbors that are too far away by some metric.

Clustering with two dimensions (KPI-value, timestamp) can be viable; with no significant autocorrelation in the data, these can be handled as independent datapoints. Rescaling the KPI-value and timestamp dimensions to roughly the same scale can be done before input to the clustering algorithm. Different scaling techniques can be used, including Z-score which is based on distance from data mean divided by data variance.

Although clustering algorithms such as DBSCAN can identify an arbitrary number of clusters, this module has the goal of identifying only outliers and non-outliers. As such, the module can identify a “main” cluster in the center (e.g., near the mean) and one or more other clusters further from the mean. The other clusters are postprocessed to identify whether they are outliers or belong to the main cluster. The module can be implemented as a streaming algorithm such that new datapoints can be labelled as outlier or non-outlier shortly after their arrivals.

Subsequently, the Anomaly Ranking Module (880) ranks any detected anomalies based on their exposure, frequency, and importance in the network. In other words, anomalies are ranked and filtered by attributes such as their deviation from the normal value, duration of deviation, and/or impact of deviation on network (e.g., number of subscribers affected, volume of traffic affected, value of services affected, etc.). In this manner, this module attempts to identify the most relevant and/or significant anomalies, including possible “root cause” anomalies and likely side-effects. For example, among concurrently detected anomalies, the ones with highest deviation from normal behavior are often the ones with the most impact on sessions and/or subscribers. These anomalies are indicated of root causes while other detected anomalies are indicative of side effects of these root causes.

Put differently, the anomaly ranking module identifies and ranks the most significant anomalies with the most specific filtering dimensions. This corresponds to the marginal distributions with the highest deviations from their respective normal behaviors. This ranking can be utilized by the user interface (UI 890) to filter and/or sort the anomalies to focus on most relevant network issues.

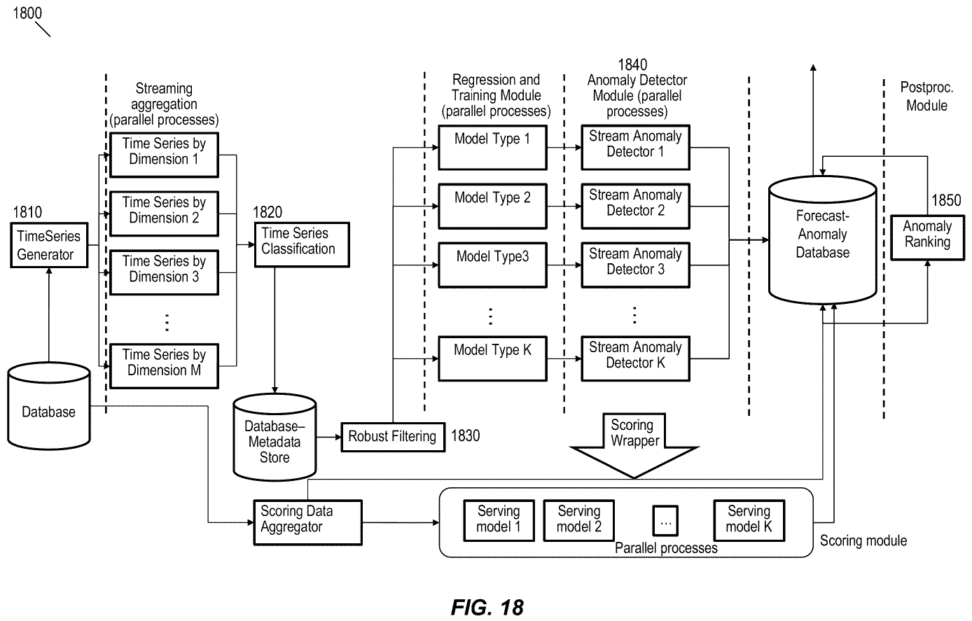

FIG. 18 shows an exemplary implementation of a network analytics system (1800) according to embodiments of the present disclosure. In particular, this implementation is targeted for a cloud-computing (or more simply “cloud”) environment.

The cloud implementation shown in FIG. 18 includes a time series generator module (1810), a time series classification module (1820), a robust filtering module (1830), one or more anomaly detector modules (1840), and an anomaly ranking module (1850). These modules can perform similar functions/operations as corresponding modules in FIG. 8, but re implemented with interfaces and parallel processes that can be scaled for a cloud environment. Training and invocation methodology is described below for this implementation.

The system receives input data through a stream serving module and collects it for a given duration. The Time Series Generator module can trigger streaming aggregation to generate M different single-or multi-dimensional time series. These are input to the Time Series Behavior Detector module that classifies each time series according to behavior and sends the K time series and classification metadata to a persistent database.

One the Time Series Behavior Detector module finishes it triggers the Robust Filtering Module, that identifies frequent patterns and commonalities in the M time series and clears out undesired behaviors. This can be done, for example, based on unsupervised learning techniques These M more robust time series are used for regression and training of different model types that, for example, can be pre-defined in the system. If there are M time series there can be at most M model types, but the arrangement in FIG. 18 assumes K<M model types. The number of model types also depends on the available resources of the cloud computing platform. The regression and training of the K different model types can be done in parallel.

After regression and training, the M time series and their learned behavior (i.e., the K model types) are handed over to Anomaly Detection Modules, here shown as one per model type. These modules detect anomalies based on the K models in any of the ways described above.

A Scoring Proxy wraps the K models as serving models that can be used for batch-and streaming-based prediction processing via REST APIs. The Scoring Proxy REST API also writes the detected anomalies into a persistent database, correlated with the original time series data collected from the network. This persistent database is latter queried by the Anomaly Ranking Module, which for the end user will trigger the UI for the ranking. All the results at this point can be transferred to a persistent database for the end UI usage.

Open RAN (O-RAN) ALLIANCE is a community of mobile operators and RAN vendors working towards an open, intelligent, virtualized, operationally efficient, and fully interoperable RANs. To achieve these goals, the community has defined an O-RAN Architecture with key functions and interfaces. Various specifications published by O-RAN work groups (WGs). For example, O-RAN WG1 is concerned with use cases and overall architecture. One general principle is that O-RAN architecture and interface specifications shall be consistent with 3GPP architecture and interface specifications, to the extent possible.

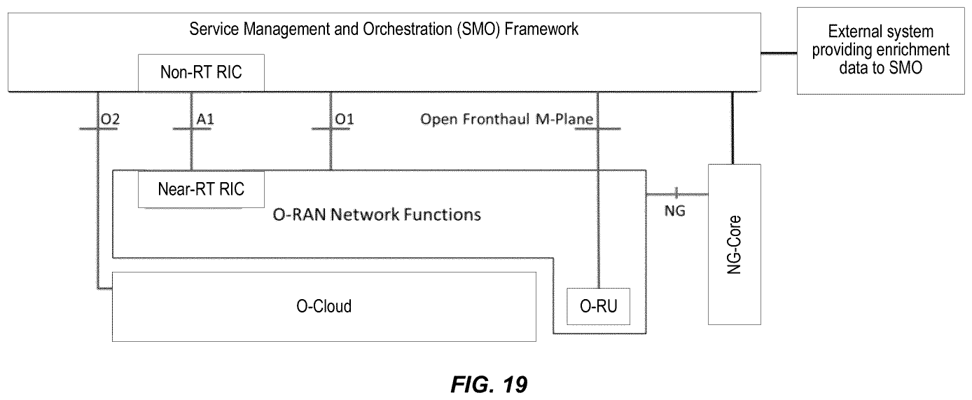

FIG. 19 shows the high-level O-RAN architecture and four key interfaces A1, O1, Open Fronthaul M-plane, and O2. These interfaces connect the Service Management and Orchestration (SMO) framework to O-RAN network functions (NFs) and the Open Cloud (O-Cloud). Additionally, there is an interface between SMO and external systems that can provide enrichment data. Also shown is the NG interface between O-RAN NFs and the NG-Core, which is consistent with the NG interface with 5GC shown in FIG. 1.

The O-RAN Architecture Description defines the following three control loops with respective latencies:
Real Time (RT) Control Loop (<10 ms);
Near-RT RIC Control Loop (10-1000 ms); and
Non-RT RIC Control Loop (>1000 ms).

Use cases for Non-RT RIC and Near-RT RIC control loops are fully defined by O-RAN, but O-RAN only defines relevant interactions with other O-RAN nodes or functions for the RT control loop (which performs radio scheduling, HARQ, beamforming, etc.).

The Non-RT RIC provides the Al interface to the Near-RT RIC. One task of Non-RT RIC is to provide policy-based guidance, machine learning (ML) model management, and enrichment information to support intelligent RAN optimization by the Near-RT RIC (e.g., for radio resource management, RRM). The Non-RT RIC can also perform intelligent RRM in longer, non-RT intervals (e.g., greater than 1 second).

The Non-RT RIC can use data analytics and artificial intelligence (AI)/ML training and inference to determine RAN optimizations, for which it can leverage SMO services such as data collection from and provisioning to the O-RAN nodes. These actions are performed by Non-RT RIC Applications (rApps). The Non-RT RIC also includes the Non-RT RIC Framework, which is internal to the SMO Framework, logically terminates the Al interface, and exposes all required functionality and services to rApps.

As currently specified, the O-RAN architecture does not include any components and/or interfaces that enable input data flows from existing data collection components for cross-domain correlation. For example, the SMO Non-RT RIC component does not have any data interfaces towards domains other than RAN. More generally, input data from non-RAN domains (e.g., CN, Application, etc.) are out of scope of O-RAN. Even so, there are different possible implementation options for integrating embodiments of the present disclosure into O-RAN architecture are described below.

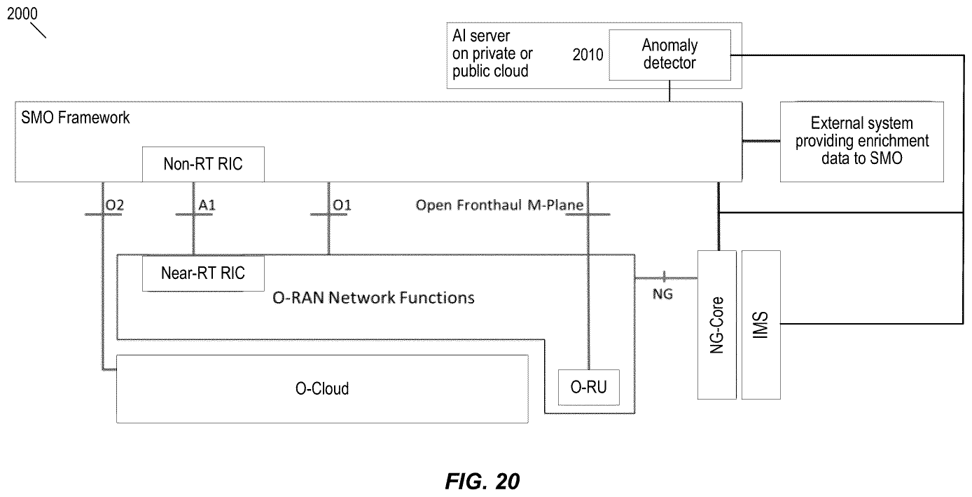

FIG. 20 shows a first implementation option for integrating embodiments of the present disclosure in a multi-domain network (2000) that includes the O-RAN architecture. In this option, the anomaly detector (2010) with cross-domain data correlation runs on an AI server outside of SMO (e.g., on public or private cloud computing environment), and has an external interface into SMO. The anomaly detector also has external interfaces that facilitate data collection from other domains such as CN (e.g., 5GC), IMS, etc.

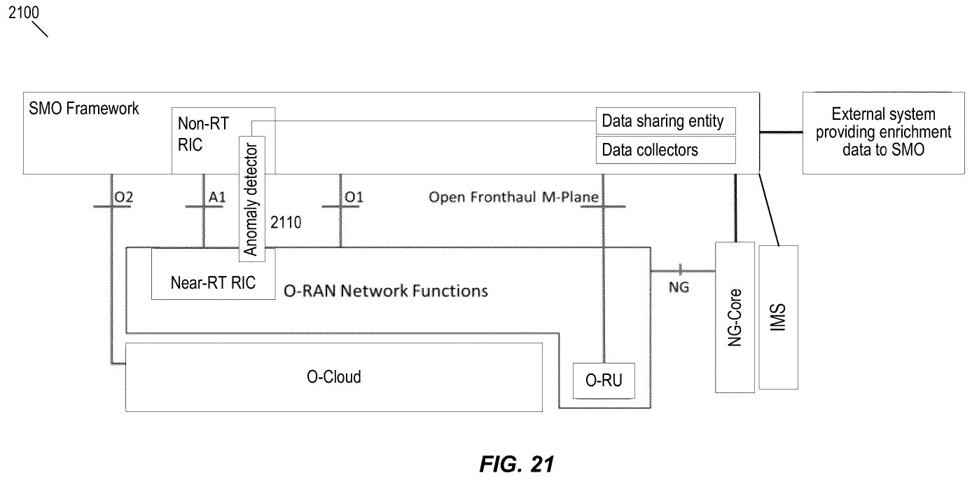

FIG. 21 shows a second implementation option for integrating embodiments of the present disclosure in a multi-domain network (2100) that includes the O-RAN architecture. In this option, the anomaly detector (2110) with cross-domain data correlation runs in the Non-RT RIC and optionally partially within the Near-RT RIC. For example, “training” components such as time series behavior detection, decomposer, and de-trending can be run in the Non-RT RIC with the anomaly detection logic run in either Non-RT RIC or Near-RT RIC, depending on latency requirements.

Both these implementation options are applicable to cases where data collection and correlation is performed within the RAN only and to cases where data collection and correlation is also performed across other network domains (e.g., CN and IMS).

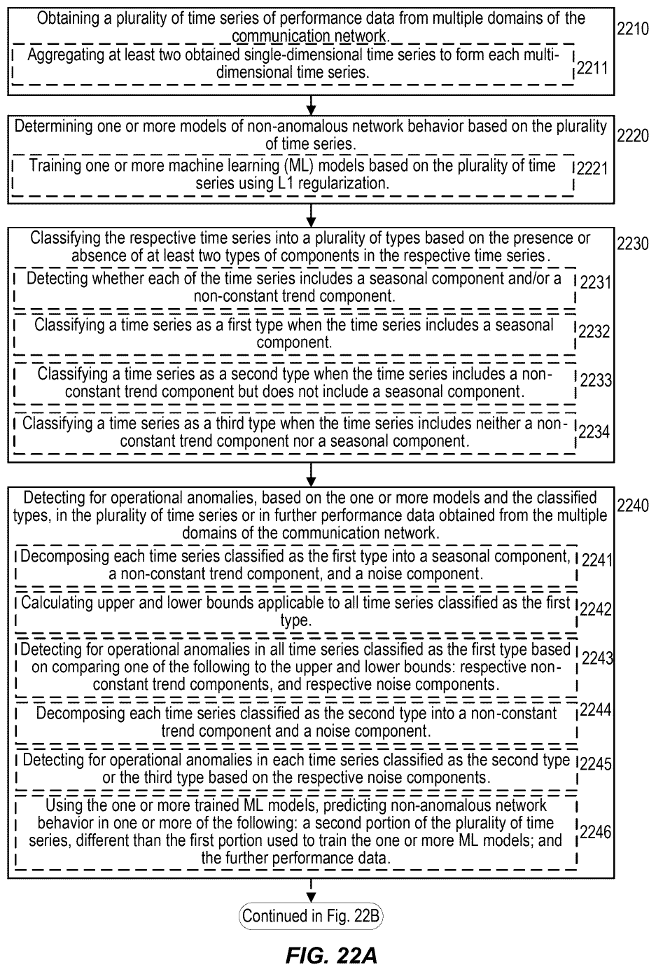

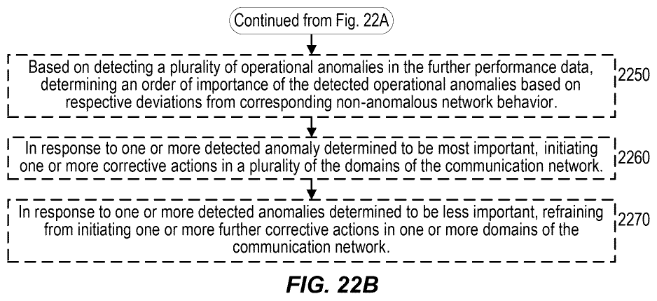

Various features of the embodiments described above correspond to various operations illustrated in FIG. 22 (including parts A and B), which depicts an exemplary method (e.g., procedure) for detecting operational anomalies in a multi-domain communication network, according to various embodiments of the present disclosure. In other words, various features of the operations described below correspond to various embodiments described above. Although FIG. 22 shows specific blocks in a particular order, the operations of the exemplary method can be performed in a different order than shown and can be combined and/or divided into blocks having different functionality than shown. Optional blocks or operations are indicated by dashed lines.

The following description is based on the exemplary method being performed by a network analytics system associated with the communication network. For example, the network analytics system can be implemented in (or as) a service management and orchestration (SMO) system for a RAN, an analytics-related CN node such as NWDAF, a network management node in an OAM system, or an application running in a host computing system external to the network (e.g., public or private cloud environment).

The exemplary method can include the operations of block 2210, where the network analytics system can obtain a plurality of time series of performance data from multiple domains of the communication network. The exemplary method can also include the operations of block 2220, where the network analytics system can determine one or more models of non-anomalous network behavior based on the plurality of time series. The exemplary method can also include the operations of block 2230, where the network analytics system can classify the respective time series into a plurality of types based on the presence or absence of at least two types of components in the respective time series. The exemplary method can also include the operations of block 2240, where the network analytics system can detect for operational anomalies, based on the one or more models and the classified types, in the plurality of time series or in further performance data obtained from the multiple domains of the communication network.

In some embodiments, the exemplary method can also include the operations of block 2250, where based on detecting a plurality of operational anomalies in the further performance data, the network analytics system can determine an order of importance of the detected operational anomalies based on respective deviations from corresponding non-anomalous network behavior. In some of these embodiments, the exemplary method can also include the operations of block 2260, where in response to one or more detected anomalies determined to be most important, the network analytics system can initiate one or more corrective actions in a plurality of the domains of the communication network. In some of these embodiments, the exemplary method can also include the operations of block 2270, where in response to one or more detected anomalies determined to be less important, the network analytics system can refrain from initiating one or more further corrective actions in one or more domains of the communication network.

In some embodiments, one or more of the following applies:
each time series comprises data samples from one of the following in a single domain: a network element, or an interface between network elements; and
the operational anomalies are detected in a plurality of time series collected from a plurality of domains.

In some embodiments, classifying the respective time series based on the presence or absence of at least two types of components in block 2230 includes the following operations, labelled with corresponding sub-block numbers:
(2231) detecting whether each of the time series includes a seasonal component and/or a non-constant trend component;
(2232) classifying a time series as a first type when the time series includes a seasonal component;
(2233) classifying a time series as a second type when the time series includes a non-constant trend component but does not include a seasonal component; and
(2234) classifying a time series as a third type when the time series includes neither a non-constant trend component nor a seasonal component.

In some of these embodiments, one or more of the following applies:
detecting whether each of the time series includes a seasonal component in sub-block 2231 is based on one of the following statistical tests: a Welch test, or a QS test; and
detecting whether each of the time series includes a non-constant trend component in sub-block 2231 is based on one of the following: a stationarity test, a Kolmogorov-Smirnov test, or a neural network autoencoder.

In some of these embodiments, detecting for operational anomalies in the plurality of time series in block 2240 includes the following operations, labelled with corresponding sub-block numbers:
(2241) decomposing each time series classified as the first type into a seasonal component, a non-constant trend component, and a noise component; and
(2242) calculating upper and lower bounds applicable to all time series classified as the first type; and
(2243) detecting for operational anomalies in each time series classified as the first type based on comparing one of the following to the upper and lower bounds: respective non-constant trend components, and respective noise components.

In some of these embodiments, each time series classified as the third type includes a noise component. In such embodiments, detecting for operational anomalies in the plurality of time series in block 2240 includes the following operations, labelled with corresponding sub-block numbers:
(2244) decomposing each time series classified as the second type into a non-constant trend component and a noise component; and
(2245) detecting for operational anomalies in each time series classified as the second type or the third type based on the respective noise components.

In some variants, each noise component includes a series of tuples, with each tuple including a data value and a corresponding time instant. In such variants, detecting for operational anomalies in each time series classified as the second type or the third type in sub block 2245 includes the following operations, labelled with corresponding sub-sub-block numbers:
(2245a) rescaling the data values and/or the time instants comprising the tuples of the noise component; and
(2245b) detecting for operational anomalies based on arranging the tuples into a plurality of clusters, including a cluster of non-outliers and at least one cluster of outliers.

In some embodiments, determining one or more models of non-anomalous network behavior based on the plurality of time series in block 2220 includes the operations of sub-block 2221, where the network analytics system can train one or more machine learning (ML) models based on the plurality of time series using L1 regularization. For example, each ML model comprises a neural network (NN) having a plurality of weights and training the one or more ML models using L1 regularization in sub-block 2221 includes the operations of sub-sub-block 2221a, where the network analytics system can minimize, for each ML model, a loss function of the NN weights and of a norm of the NN weights.

In some of these embodiments, detecting for operational anomalies based on the one or more models in block 2240 includes the operations of sub-block 2246, where using the one or more trained ML models, the network analytics system can predict non-anomalous network behavior in one or more of the following:
a second portion of the plurality of time series, different than the first portion used to train the one or more ML models; and
the further performance data obtained from the multiple domains of the communication network.

For example, detecting for operational anomalies in block 2240 is based on the non-anomalous network behavior predicted in sub-block 2246 using the one or more trained ML models.

In some embodiments, the number of models of non-anomalous network behavior (e.g., determined in block 2220) is less than the number of time series. In some embodiments, the plurality of time series represent a corresponding plurality of marginal distributions of performance of the multi-domain communication system.

In some embodiments, the multiple domains include at least two of the following domains: a user equipment (UE) domain; a radio access network (RAN) domain; a core network (CN) domain; and an IP multimedia system (IMS) domain. In such embodiments, the plurality of time series include at least one time series obtained from each of the at least two domains.

In some of these embodiments, the RAN domain comprises an Open RAN (O-RAN) architecture. In such embodiments, the obtaining, determining, and classifying operations of blocks 2210-2230 are performed by an O-RAN non-real-time RAN intelligent controller (non-RT RIC), while the detecting operation of block 2240 is performed by the O-RAN non-RT RIC or by an O-RAN near-RT RIC.

In some of these embodiments, the plurality of time series include at least two of the following:
time series of one or more of the following RAN-domain quality of service (QOS) metrics: RAN resources used, serving cell load, mobility events between serving cells, and serving and neighbor cell radio measurements;
time series of one or more of the following CN-domain QoS metrics: packet delay, packet delay jitter, packet loss, and priority level;
time series of trace data for respective cells provided by RAN nodes;
time series of performance management (PM) counter values associated with the RAN nodes;
time series of user plane (UP) event information associated with the CN domain; and
time series of control plane (CP) event information associated with the CN domain.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

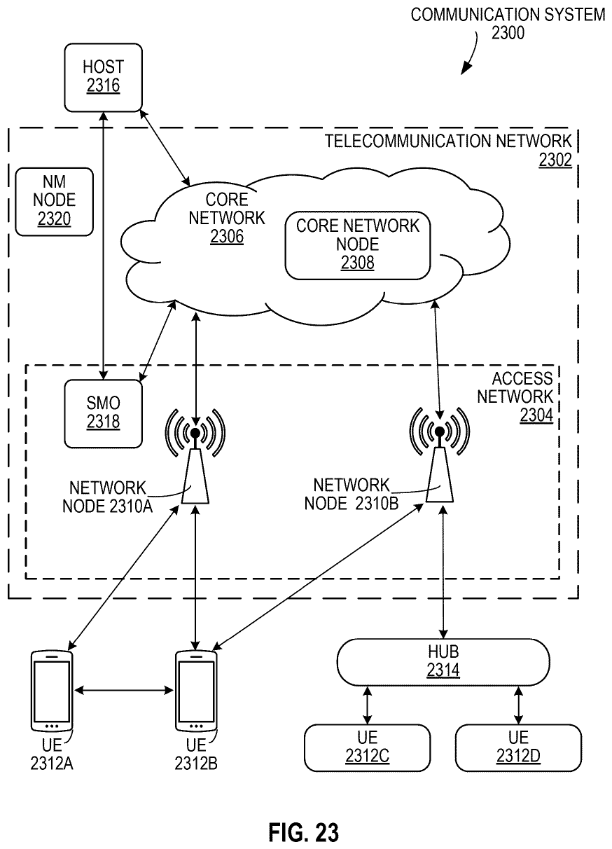

FIG. 23 shows an example of a communication system 2300 in accordance with some embodiments. In this example, the communication system 2300 includes a telecommunication network 2302 that includes an access network 2304, such as a radio access network (RAN), and a core network 2306, which includes one or more core network nodes 2308. In some embodiments, telecommunication network 2302 can also include one or more Network Management (NM) nodes 2318, which can be part of an operation support system (OSS), a business support system (BSS), and/or an OAM system. The NM nodes can monitor and/or control operations of other nodes in access network 2304 and core network 2306. Although not shown in FIG. 23, NM node 2318 is configured to communicate with other nodes in access network 2304 and core network 2306 for these purposes.

Access network 2304 includes one or more access network nodes, such as network nodes 2310a and 2310b (one or more of which may be generally referred to as network nodes 2310), or any other similar 3GPP access node or non-3GPP access point. The network nodes 2310 facilitate direct or indirect connection of UEs, such as by connecting UEs 2312a, 2312b, 2312c, and 2312d (one or more of which may be generally referred to as UEs 2312) to the core network 2306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2300 may include any number of wired or wireless networks, network nodes, UEs, and/or any other components or systems that may facilitate or participate in the communication of data and/or signals whether via wired or wireless connections. The communication system 2300 may include and/or interface with any type of communication, telecommunication, data, cellular, radio network, and/or other similar type of system.

The UEs 2312 may be any of a wide variety of communication devices, including wireless devices arranged, configured, and/or operable to communicate wirelessly with the network nodes 2310 and other communication devices. Similarly, the network nodes 2310 are arranged, capable, configured, and/or operable to communicate directly or indirectly with the UEs 2312 and/or with other network nodes or equipment in the telecommunication network 2302 to enable and/or provide network access, such as wireless network access, and/or to perform other functions, such as administration in the telecommunication network 2302.

In the depicted example, the core network 2306 connects the network nodes 2310 to one or more hosts, such as host 2316. These connections may be direct or indirect via one or more intermediary networks or devices. In other examples, network nodes may be directly coupled to hosts. The core network 2306 includes one more core network nodes (e.g., core network node 2308) that are structured with hardware and software components. Features of these components may be substantially similar to those described with respect to the UEs, network nodes, and/or hosts, such that the descriptions thereof are generally applicable to the corresponding components of the core network node 2308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2316 may be under the ownership or control of a service provider other than an operator or provider of the access network 2304 and/or the telecommunication network 2302, and may be operated by the service provider or on behalf of the service provider. The host 2316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

In some embodiments, access network 2304 can include a service management and orchestration (SMO) system or node 2320, which can monitor and/or control operations of the access network nodes 2310. This arrangement can be used, for example, when access network 2304 utilizes an Open RAN (O-RAN) architecture. SMO system 2320 can be configured to communicate with core network 2306 and/or host 2316, as shown in FIG. 23.

In some embodiments, one or more of host 2316, network management node 2318, and SMO system 2320 can be configured to perform various operations of exemplary methods (e.g., procedures) for detecting operational anomalies in a multi-domain communication network, such as described above in relation to FIG. 22.

As a whole, the communication system 2300 of FIG. 23 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2302 is a cellular network that implements 3GPP standardized features. Accordingly, the telecommunications network 2302 may support network slicing to provide different logical networks to different devices that are connected to the telecommunication network 2302. For example, the telecommunications network 2302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2312 are configured to transmit and/or receive information without direct human interaction. For instance, a UE may be designed to transmit information to the access network 2304 on a predetermined schedule, when triggered by an internal or external event, or in response to requests from the access network 2304. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 2314 communicates with the access network 2304 to facilitate indirect communication between one or more UEs (e.g., UE 2312c and/or 2312d) and network nodes (e.g., network node 2310b). In some examples, the hub 2314 may be a controller, router, content source and analytics, or any of the other communication devices described herein regarding UEs. For example, the hub 2314 may be a broadband router enabling access to the core network 2306 for the UEs. As another example, the hub 2314 may be a controller that sends commands or instructions to one or more actuators in the UEs. Commands or instructions may be received from the UEs, network nodes 2310, or by executable code, script, process, or other instructions in the hub 2314. As another example, the hub 2314 may be a data collector that acts as temporary storage for UE data and, in some embodiments, may perform analysis or other processing of the data. As another example, the hub 2314 may be a content source. For example, for a UE that is a VR headset, display, loudspeaker or other media delivery device, the hub 2314 may retrieve VR assets, video, audio, or other media or data related to sensory information via a network node, which the hub 2314 then provides to the UE either directly, after performing local processing, and/or after adding additional local content. In still another example, the hub 2314 acts as a proxy server or orchestrator for the UEs, in particular in if one or more of the UEs are low energy IoT devices.

The hub 2314 may have a constant/persistent or intermittent connection to the network node 2310b. The hub 2314 may also allow for a different communication scheme and/or schedule between the hub 2314 and UEs (e.g., UE 2312c and/or 2312d), and between the hub 2314 and the core network 2306. In other examples, the hub 2314 is connected to the core network 2306 and/or one or more UEs via a wired connection. Moreover, the hub 2314 may be configured to connect to an M2M service provider over the access network 2304 and/or to another UE over a direct connection. In some scenarios, UEs may establish a wireless connection with the network nodes 2310 while still connected via the hub 2314 via a wired or wireless connection. In some embodiments, the hub 2314 may be a dedicated hub-that is, a hub whose primary function is to route communications to/from the UEs from/to the network node 2310b. In other embodiments, the hub 2314 may be a non-dedicated hub-that is, a device which is capable of operating to route communications between the UEs and network node 2310b, but which is additionally capable of operating as a communication start and/or end point for certain data channels.

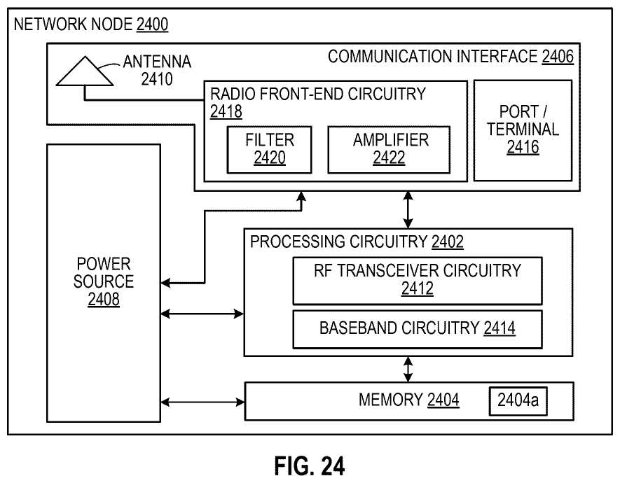

FIG. 24 shows a network node 2400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

In some embodiments, network node 2400 can be configured to perform various operations of exemplary methods (e.g., procedures) for detecting operational anomalies in a multi-domain communication network, such as described above in relation to FIG. 22.

The network node 2400 includes a processing circuitry 2402, a memory 2404, a communication interface 2406, and a power source 2408. The network node 2400 may be composed of multiple physically separate components (e.g., a NodeB component and a RNC component, or a BTS component and a BSC component, etc.), which may each have their own respective components. In certain scenarios in which the network node 2400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2400 may be configured to support multiple radio access technologies (RATs). In such embodiments, some components may be duplicated (e.g., separate memory 2404 for different RATs) and some components may be reused (e.g., a same antenna 2410 may be shared by different RATs). The network node 2400 may also include multiple sets of the various illustrated components for different wireless technologies integrated into network node 2400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2400.

The processing circuitry 2402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2400 components, such as the memory 2404, to provide network node 2400 functionality.

In some embodiments, the processing circuitry 2402 includes a system on a chip (SOC). In some embodiments, the processing circuitry 2402 includes one or more of radio frequency (RF) transceiver circuitry 2412 and baseband processing circuitry 2414. In some embodiments, the radio frequency (RF) transceiver circuitry 2412 and the baseband processing circuitry 2414 may be on separate chips (or sets of chips), boards, or units, such as radio units and digital units. In alternative embodiments, part or all of RF transceiver circuitry 2412 and baseband processing circuitry 2414 may be on the same chip or set of chips, boards, or units.

The memory 2404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2402. The memory 2404 may store any suitable instructions, data, or information, including a computer program, software, an application including one or more of logic, rules, code, tables, and/or other instructions (collectively denoted computer program product 2404a) capable of being executed by the processing circuitry 2402 and utilized by the network node 2400. The memory 2404 may be used to store any calculations made by the processing circuitry 2402 and/or any data received via the communication interface 2406. In some embodiments, the processing circuitry 2402 and memory 2404 is integrated.

The communication interface 2406 is used in wired or wireless communication of signaling and/or data between a network node, access network, and/or UE. As illustrated, the communication interface 2406 comprises port(s)/terminal(s) 2416 to send and receive data, for example to and from a network over a wired connection. The communication interface 2406 also includes radio front-end circuitry 2418 that may be coupled to, or in certain embodiments a part of, the antenna 2410. Radio front-end circuitry 2418 comprises filters 2420 and amplifiers 2422. The radio front-end circuitry 2418 may be connected to an antenna 2410 and processing circuitry 2402. The radio front-end circuitry may be configured to condition signals communicated between antenna 2410 and processing circuitry 2402. The radio front-end circuitry 2418 may receive digital data that is to be sent out to other network nodes or UEs via a wireless connection. The radio front-end circuitry 2418 may convert the digital data into a radio signal having the appropriate channel and bandwidth parameters using a combination of filters 2420 and/or amplifiers 2422. The radio signal may then be transmitted via the antenna 2410. Similarly, when receiving data, the antenna 2410 may collect radio signals which are then converted into digital data by the radio front-end circuitry 2418. The digital data may be passed to the processing circuitry 2402. In other embodiments, the communication interface may comprise different components and/or different combinations of components.

In certain alternative embodiments, the network node 2400 does not include separate radio front-end circuitry 2418, instead, the processing circuitry 2402 includes radio front-end circuitry and is connected to the antenna 2410. Similarly, in some embodiments, all or some of the RF transceiver circuitry 2412 is part of the communication interface 2406. In still other embodiments, the communication interface 2406 includes one or more ports or terminals 2416, the radio front-end circuitry 2418, and the RF transceiver circuitry 2412, as part of a radio unit (not shown), and the communication interface 2406 communicates with the baseband processing circuitry 2414, which is part of a digital unit (not shown).

The antenna 2410 may include one or more antennas, or antenna arrays, configured to send and/or receive wireless signals. The antenna 2410 may be coupled to the radio front-end circuitry 2418 and may be any type of antenna capable of transmitting and receiving data and/or signals wirelessly. In certain embodiments, the antenna 2410 is separate from the network node 2400 and connectable to the network node 2400 through an interface or port.

The antenna 2410, communication interface 2406, and/or the processing circuitry 2402 may be configured to perform any receiving operations and/or certain obtaining operations described herein as being performed by the network node. Any information, data and/or signals may be received from a UE, another network node and/or any other network equipment. Similarly, the antenna 2410, the communication interface 2406, and/or the processing circuitry 2402 may be configured to perform any transmitting operations described herein as being performed by the network node. Any information, data and/or signals may be transmitted to a UE, another network node and/or any other network equipment.

The power source 2408 provides power to the various components of network node 2400 in a form suitable for the respective components (e.g., at a voltage and current level needed for each respective component). The power source 2408 may further comprise, or be coupled to, power management circuitry to supply the components of the network node 2400 with power for performing the functionality described herein. For example, the network node 2400 may be connectable to an external power source (e.g., the power grid, an electricity outlet) via an input circuitry or interface such as an electrical cable, whereby the external power source supplies power to power circuitry of the power source 2408. As a further example, the power source 2408 may comprise a source of power in the form of a battery or battery pack which is connected to, or integrated in, power circuitry. The battery may provide backup power should the external power source fail.

Embodiments of the network node 2400 may include additional components beyond those shown in FIG. 24 for providing certain aspects of the network node's functionality, including any of the functionality described herein and/or any functionality necessary to support the subject matter described herein. For example, the network node 2400 may include user interface equipment to allow input of information into the network node 2400 and to allow output of information from the network node 2400. This may allow a user to perform diagnostic, maintenance, repair, and other administrative functions for the network node 2400.

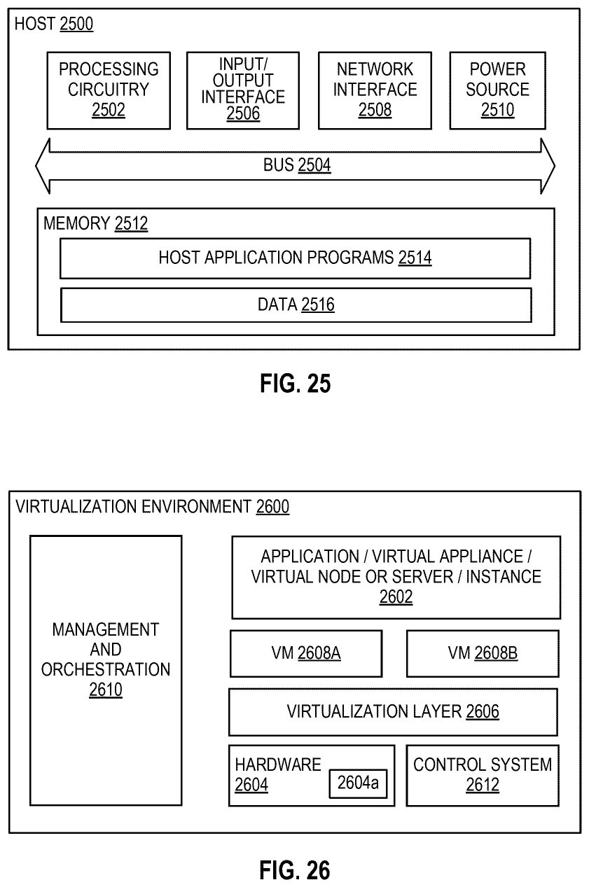

FIG. 25 is a block diagram of a host 2500, which may be an embodiment of the host 2316 of FIG. 23, in accordance with various aspects described herein. As used herein, the host 2500 may be or comprise various combinations hardware and/or software, including a standalone server, a blade server, a cloud-implemented server, a distributed server, a virtual machine, container, or processing resources in a server farm. The host 2500 may provide one or more services to one or more UEs.

The host 2500 includes processing circuitry 2502 that is operatively coupled via a bus 2504 to an input/output interface 2506, a network interface 2508, a power source 2510, and a memory 2512. Other components may be included in other embodiments. Features of these components may be substantially similar to those described with respect to the devices of previous figures, such as FIG. 24, such that the descriptions thereof are generally applicable to the corresponding components of host 2500.

The memory 2512 may include one or more computer programs including one or more host application programs 2514 and data 2516, which may include user data, e.g., data generated by a UE for the host 2500 or data generated by the host 2500 for a UE. Embodiments of the host 2500 may utilize only a subset or all of the components shown. The host application programs 2514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2514 may also provide for user authentication and licensing checks and may periodically report health, routes, and content availability to a central node, such as a device in or on the edge of a core network. Accordingly, the host 2500 may select and/or indicate a different host for over-the-top services for a UE. The host application programs 2514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

In some embodiments, host 2500 can be configured to perform various operations of exemplary methods (e.g., procedures) for detecting operational anomalies in a multi-domain communication network, such as described above in relation to FIG. 22.

FIG. 26 is a block diagram illustrating a virtualization environment 2600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2602 (which may alternatively be called software instances, virtual appliances, network functions, virtual nodes, virtual network functions, etc.) are run in the virtualization environment 2600 to implement some of the features, functions, and/or benefits of some of the embodiments disclosed herein. In some embodiments, one or more applications 2602 can be configured to perform various operations of exemplary methods (e.g., procedures) for detecting operational anomalies in a multi-domain communication network, such as described above in relation to FIG. 22.

Hardware 2604 includes processing circuitry, memory that stores software and/or instructions (collectively denoted computer program product 2604a) executable by hardware processing circuitry, and/or other hardware devices as described herein, such as a network interface, input/output interface, and so forth. Software may be executed by the processing circuitry to instantiate one or more virtualization layers 2606 (also referred to as hypervisors or virtual machine monitors (VMMs)), provide VMs 2608a and 2608b (one or more of which may be generally referred to as VMs 2608), and/or perform any of the functions, features and/or benefits described in relation with some embodiments described herein. The virtualization layer 2606 may present a virtual operating platform that appears like networking hardware to the VMs 2608.

The VMs 2608 comprise virtual processing, virtual memory, virtual networking or interface and virtual storage, and may be run by a corresponding virtualization layer 2606. Different embodiments of the instance of a virtual appliance 2602 may be implemented on one or more of VMs 2608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2608 may be a software implementation of a physical machine that runs programs as if they were executing on a physical, non-virtualized machine. Each of the VMs 2608, and that part of hardware 2604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2608 on top of the hardware 2604 and corresponds to the application 2602.

Hardware 2604 may be implemented in a standalone network node with generic or specific components. Hardware 2604 may implement some functions via virtualization. Alternatively, hardware 2604 may be part of a larger cluster of hardware (e.g., such as in a data center or CPE) where many hardware nodes work together and are managed via management and orchestration 2610, which, among others, oversees lifecycle management of applications 2602. In some embodiments, hardware 2604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2612 which may alternatively be used for communication between hardware nodes and radio units.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

1. A computer-implemented method for detecting operational anomalies in a multi-domain communication network, the method comprising:
obtaining a plurality of time series of performance data from multiple domains of the communication network;
determining one or more models of non-anomalous network behavior based on the plurality of time series;
classifying the respective time series into a plurality of types based on the presence or absence of at least two types of components in the respective time series; and
detecting for operational anomalies, based on the one or more models and the classified types, in the plurality of time series or in further performance data obtained from the multiple domains of the communication network.

2. The method of claim 1, further comprising, based on detecting a plurality of operational anomalies in the further performance data, determining an order of importance of the detected operational anomalies based on respective deviations from corresponding non-anomalous network behavior.

3. The method of claim 2, further comprising one or more of the following:
in response to one or more detected anomaly determined to be most important, initiating one or more corrective actions in a plurality of the domains of the communication network; and
in response to one or more detected anomalies determined to be less important, refraining from initiating one or more further corrective actions in one or more domains of the communication network.

4. The method of claim 1, wherein one or more of the following applies:
each time series comprises data samples from one of the following in a single domain: a network element, or an interface between network elements; and
the operational anomalies are detected in a plurality of time series collected from a plurality of domains.

5. The method of claim 1, wherein classifying the respective time series based on the presence or absence of at least two types of components comprises:
detecting whether each of the time series includes a seasonal component and/or a non-constant trend component;
classifying a time series as a first type when the time series includes a seasonal component;
classifying a time series as a second type when the time series includes a non-constant trend component but does not include a seasonal component; and
classifying a time series as a third type when the time series includes neither a non-constant trend component nor a seasonal component.

6. The method of claim 5, wherein one or more of the following applies:
detecting whether each of the time series includes a seasonal component is based on one of the following statistical tests: a Welch test, or a QS test; and
detecting whether each of the time series includes a non-constant trend component is based on one of the following: a stationarity test, a Kolmogorov-Smirnov test, or a neural network autoencoder.

7. The method of claim 5, wherein detecting for operational anomalies in the plurality of time series comprises:
decomposing each time series classified as the first type into a seasonal component, a non-constant trend component, and a noise component; and
calculating upper and lower bounds applicable to all time series classified as the first type; and
detecting for operational anomalies in each time series classified as the first type based on comparing one of the following to the upper and lower bounds:
respective non-constant trend components, and respective noise components.

8. The method of claim 5 wherein:
each time series classified as the third type includes a noise component; and
detecting for operational anomalies in the plurality of time series comprises:
decomposing each time series classified as the second type into a non-constant trend component and a noise component; and
detecting for operational anomalies in each time series classified as the second type or the third type based on the respective noise components.

9. The method of claim 8, wherein:
each noise component includes a series of tuples, with each tuple including a data value and a corresponding time instant; and
detecting for operational anomalies in each time series classified as the second type or the third type comprises:
rescaling the data values or the time instants comprising the tuples of the noise component; and
detecting for operational anomalies based on arranging the tuples into a plurality of clusters, including a cluster of non-outliers and at least one cluster of outliers.

10. The method of claim 1, wherein determining one or more models of non-anomalous network behavior based on the plurality of time series comprises training one or more machine learning, ML, models based on the plurality of time series using L1 regularization.

11. The method of claim 10, wherein:
each ML model comprises a neural network, NN, having a plurality of weights; and
training the one or more ML models using L1 regularization comprises minimizing, for each ML model, a loss function of the NN weights and of a norm of the NN weights.

12. The method of claim 10, wherein detecting for operational anomalies based on the one or more models comprises, using the one or more trained ML models, predicting non-anomalous network behavior in one or more of the following:
a second portion of the plurality of time series, different than the first portion used to train the one or more ML models; and
the further performance data obtained from the multiple domains of the communication network.

13. The method of claim 12, wherein detecting for operational anomalies is based on the non-anomalous network behavior predicted using the one or more trained ML models.

14. The method of claim 1, wherein the plurality of time series comprise one or more multi-dimensional time series, and obtaining the plurality of time series comprises aggregating at least two obtained single-dimensional time series to form each multi-dimensional time series.

15. The method of claim 1, wherein the number of models of non-anomalous network behavior is less than the number of time series.

16. The method of claim 1, wherein the plurality of time series represent a corresponding plurality of marginal distributions of performance of the multi-domain communication system.

17. The method of claim 1, wherein:
the multiple domains include at least two of the following domains: a user equipment, UE, domain; a radio access network, RAN, domain; a core network, CN, domain; and an IP multimedia system, IMS, domain; and
the plurality of time series include at least one time series obtained from each of the at least two domains.

18. The method of claim 17, wherein:
the RAN domain comprises an Open RAN, O-RAN, architecture;
the obtaining, determining, and classifying operations are performed by an O-RAN non-real-time RAN intelligent controller, non-RT RIC; and
the detecting operation is performed by the O-RAN non-RT RIC or by an O-RAN near-RT RIC.

19. The method of claim 17, wherein the plurality of time series include at least two of the following:
time series of one or more of the following RAN-domain quality of service, QoS, metrics: RAN resources used, serving cell load, mobility events between serving cells, and serving and neighbor cell radio measurements;
time series of one or more of the following CN-domain QoS metrics: packet delay, packet delay jitter, packet loss, and priority level;
time series of trace data for respective cells provided by RAN nodes;
time series of performance management, PM, counter values associated with the RAN nodes;
time series of user plane, UP, event information associated with the CN domain; and
time series of control plane, CP, event information associated with the CN domain.

20. A network analytics system configured to detect operational anomalies in a multi-domain communication network, the network analytics system comprising:
communication interface circuitry configured to communicate with multiple domains of the communication network; and
processing circuitry that is operably coupled to the communication interface circuitry, whereby the processing circuitry and the communication interface circuitry are configured to:
obtain a plurality of time series of performance data from the multiple domains of the communication network;
determine one or more models of non-anomalous network behavior based on the plurality of time series;
classify the respective time series into a plurality of types based on the presence or absence of at least two types of components in the respective time series; and
detect for operational anomalies, based on the one or more models and the classified types, in the plurality of time series or in further performance data obtained from the multiple domains of the communication network.

21-26. (canceled)
